(19) United States
(12) Patent Application Publication
(10) Pub. No.: US 2025/0356174 A1
(43) Pub. Date: Nov. 20, 2025

(54) SPIKE INTERCONNECT ON CHIP SINGLE-PACKET MULTICAST

(71) Applicant: INNATERA NANOSYSTEMS B.V., Rijswijk (NL)

(72) Inventors: Shashanka Marigi RAJANARAYANA, Delft (NL); Anushree MAHAPATRA, Voorburg (NL); Jinbo ZHOU, Eindhoven (NL)

(21) Appl. No.: 18/873,368

(22) PCT Filed: Jun. 15, 2023
(86) PCT No.: PCT/EP2023/066183

§ 371 Date: Dec. 10, 2024

Related U.S. Application Data
(60) Provisional application No. 63/352,650, filed on Jun. 16, 2022.

(51) Int. Cl. G06N 3/049; G06N 3/063; H04L 49/109; H04L 49/201

(52) U.S. Cl. CPC G06N 3/049; G06N 3/063; H04L 49/109; H04L 49/201

(57) ABSTRACT

A method for routing spikes in a neuromorphic processor, comprising a plurality of neuromorphic array cores each with an associated router. The method comprises generating spike data representing spike(s) produced by neuron(s) in a source neuromorphic array core. A spike data packet is generated containing the spike data, a destination vector, and a source core identity. The spike data packet is transmitted to one or more of the routers. On the basis of the destination vector it is determined whether the receiving neuromorphic array core is a destination. If so, the spike data is sent to the receiving neuromorphic array core. Furthermore, it is determined whether there are additional destinations. If so, the destination vector is updated. Furthermore, one or more next destinations are determined; and the spike data packet or a copy of the spike data packet is sent to one or more output ports of the router.

### TECHNICAL FIELD

This disclosure generally relates to neuromorphic processors, in particular to neuromorphic arrays which form a Spike Interconnect on Chip, and the routing methods used to communicate between different cores of the neuromorphic array.

### BACKGROUND

Neuromorphic computing is an approach to computing that is inspired by the structure and function of the human brain. In biological neural network models, each individual neuron communicates asynchronously and through sparse events, or spikes. In such event-based spiking neural networks (SNNs), only neurons who change the state generate spikes and may trigger signal processing in subsequent layers, consequently, saving computational resources.

SNNs encode information in the form of these one or more precisely timed (voltage) spikes, rather than as integer or real-valued vectors. Computations for inference (i.e. inferring the presence of a certain feature in an input signal) are effectively performed in the analog and temporal domains. For this reason, SNNs are typically realized in hardware as full-custom mixed signal integrated circuits. This enables them to perform inference functions with several orders of magnitude lower energy consumption than their artificial neural network counterparts.

A neuromorphic processor in general thus comprises an array of spiking neurons and synapses. Spiking neurons thus receive inputs from one or more synapses and generate spikes when the input reaches a certain predetermined threshold. The exact timing of when a spike occurs depends on the strength and sequence of input stimuli.

SNNs comprise a network of spiking neurons interconnected by synapses that dictate the strength of the connections between the spiking neurons. This strength is represented as a weight, which moderates the effect of the output of a pre-synaptic neuron on the input to a post-synaptic neuron. Typically, these weights are set in a training process that involves exposing the network to a large volume of labelled input data, and gradually adjusting the weights of the synapses until a desired network output is achieved.

SNNs can be directly applied to pattern recognition and sensor data fusion, relying on the principle that amplitude-domain, time-domain, and frequency domain features in an input signal can be encoded into unique spatial- and temporal-coded spike sequences.

The generation of these sequences relies on the use of one or more ensembles of spiking neurons, an ensemble being a co-operating group of neurons. Each ensemble performs a specific signal processing function, for example feature encoding, conditioning, filtering, data fusion, classification. Each ensemble comprises of one or more interconnected layers of spiking neurons, with the connectivity within and between layers following a certain topology. The size of each ensemble (the number of neurons), their connectivity (topology and number of synapses), and their configuration (weights and number of layers) are dependent on the characteristics of the input signal, for example dynamic range, bandwidth, timescales or complexity of features in the input signal.

Commonly, as complexity increases of features to be recognized in an input signal, so does the size of ensembles required to process them. Spiking neural network hardware can utilize configurable arrays of spiking neurons, synapses, connected using a programmable interconnect structure that facilitates the implementation of any arbitrary connection topology. However, in order to implement a large ensemble, it is necessary that the underlying SNN hardware have at least as many neurons and synapses as required.

The need for network-on-chip architectures stems from communication channel efficiency between neuronal arrays (independent of the implementation, hence valid for both analog or digital/discrete implementation of those arrays), where the communication throughput efficiency is evaluated according specific criteria such as capacity of the channel, latency, temporal dispersion (i.e. latency distribution), and integrity of the channel (i.e. the success rate of the spikes delivery to the correct destination).

In PCT/EP2019/081662, it was proposed to partition the SNN into multiple subnetworks. Each subnetwork comprises a sub-set of the spiking neurons connected to receive synaptic output signals from a subset of the synaptic elements. Furthermore, each subnetwork is adapted to generate a subnetwork output pattern signal in response to a subnetwork input pattern signal applied to the sub-network. Furthermore, each subnetwork forms part of one or multiple cores in an array of cores, each core comprising of a programmable network of spiking neurons implemented in hardware or a combination of hardware and software, and communication between cores in the core array is arranged through a programmable interconnect structure.

The neuromorphic processor that results may form a neuromorphic array which can comprise multiple neuromorphic array (NMA) cores, which are interconnected. Such an interconnect may form a network of cores, which can be on a single chip, forming a Network on Chip (NoC).

By partitioning large spiking neural networks into smaller sub-networks and implementing each of the sub-networks on one or more cores, one can make the amount of neurons in each core small and the cores can communicate with each other via the NoC.

A sub-network, or ensemble of neurons that form a co-operative group can for example form a classifier, an ensemble of classifiers, groups of neurons that handle data conversion, feature encoding or solely the classification, et cetera.

In such a regime, a large network of ensembles is partitioned and mapped onto an array of cores, each of which contains a programmable network of spiking neurons. Each core consequently implements a single ensemble, multiple small ensembles (in relation to the number of neurons and synapses in the core), or in the case of large ensembles, only a part of a single ensemble, with other parts implemented on other cores of the array. The modalities of how ensembles are partitioned and mapped to cores is determined by a mapping methodology.

The mapping methodology can comprise a constraint-driven partitioning, but other mapping methodologies are also possible. The constraint can be a performance metric linked to the function of each respective sub-network. The performance metric could be dependent on number of hops for the packet to travel between cores, minimum distance between cores, power-area limitations, memory structures, memory access, time constants, biasing, technology restrictions, resilience, a level of accepted mismatch, and/or network or physical artifacts.

The periphery of the array includes rows of the synaptic circuits which mimic the action of the soma and axon hillock of biological neurons. Further, each neuro-synaptic core in the array has a local router, which communicates with the routers of other cores within a dedicated real-time reconfigurable network-on-chip.

The local routers and their connections form a programmable interconnect structure between the cores of the core array. The cores may be connected through a switchable matrix. The different cores of the core array are thus connected via the programmable interconnect structure. In particular, the different parts of the spiking neural network implemented on different cores of the core array are interconnected through the programmable interconnect structure. In this way, quantum effects and external noise only act on each core individually, but not on the network as a whole. Hence, these effects can be mitigated if relevant.

The implemented spiking neural network on the core array can have high modularity, in the sense that the spiking neural network has dense connections between the neurons within cores but sparse connections between different cores. In this way, noise and quantum effects are reduced even more between cores while still allowing for subnetworks to increase for example classification accuracy by allowing high complexity.

The communication between neurons in a neuromorphic array comprises spike events. A spike event may be encoded simply as the identifier of the neuron where the spike occurred, or additionally, the relative timestamp (e.g., with respect to the previous spike that has occurred) at which the event was generated, and the magnitude of the spiking response generated by the neuron. Across all modalities, every time a spike occurs, it needs to be communicated to all synapses to which that spiking neuron is connected. The spike events are relayed to other cores in data packets called spike packets.

Spike packets are the communication units between NMA cores which produce spikes and also consume different spikes.

The programmable interconnect structure can form a packet switching network between the cores in the core array. These connections can form a digital network. The data can for example be output of one of the sub-networks of the spiking neural network that was partitioned and implemented on one or more cores of the core array.

The routing of these spike packets involves charting a path with a number of spike routers and physical links, through which the spike packets are forwarded depending on the routing algorithm to reach the destination node from the source node. The spike router present in every node can have multiple input and output ports. Each spike router has an ID and the spike packet may contain the destination spike router ID for the intermediate spike router(s) to route the spike packet towards the required destination depending on the router algorithm.

Some known examples for routing techniques are presented below.

A first example is deterministic routing, where the path between the source and destination is determined ahead. This technique preserves the packet order and may be free of deadlocks. This approach will not utilize all the ports of the routers and other connections (paths) of the interconnect to balance the network.

A second example of a routing technique is dimension-order routing; this technique calculates the shortest deterministic path between source and destination in the three topologies mentioned above. The packet is routed along a particular direction first and then in the other direction until it reaches the desired destination. For example, in a 2D Mesh, following the XY dimension routing algorithm, the packet is routed in the X-dimension until it reaches the X-coordinate of the destination router and thereafter it is routed along the Y-dimension until it reaches the Y-coordinate of the destination router, which is the final destination router.

The neural network mapped onto the multi-core NMA chip may be of several different natures; it can be a fully connected network, partially connected, recurrent connection, skip-layer connection, etc. Thus, there is a possibility that spikes need to be sent from one core to multiple cores. The mapping of neural network neurons onto the NMA decides the flow of spike packets in the interconnect. The one-to-many nature of the neural network requires the spike packet to be multicast to different NMA cores.

The sending of a spike packet from one core to multiple cores is called multicast communication, which can be unicast-based. In this approach, the multicast operation is performed by replicating the payload for every destination or a subset of destinations. The packets contain the same payload but different destination ids. This approach sends N packets if there are N destinations. This approach has significant network latency and high-power consumption.

The state of the art for multicast communication is unicast-based, which is shown in more detail in FIG. 3 and will be explained below. This approach may create a lot of packets in the interconnect and may lead to congestion. Furthermore, it may be burdensome on the source node to produce unnecessary extra spike packets. New routing techniques are therefore required.

### SUMMARY OF INVENTION

In one aspect, the invention comprises a method for routing spikes in a neuromorphic processor. The neuromorphic processor comprises a plurality of neuromorphic array cores each with an associated router. The neuromorphic array cores may each comprise a spiking neural network comprising a plurality of neurons connected via synapses. The method comprises generating spike data representing one or more spikes produced by one or more neurons in a source neuromorphic array core among the plurality of neuromorphic array cores; generating a spike data packet containing the spike data, a destination vector indicating one or more destinations for the spike data packet, and a source identity indicating the source neuromorphic array core; transmitting the spike data packet to one or more of the routers of the neuromorphic processor; receiving the spike data packet in a router of a receiving neuromorphic array core among the plurality of neuromorphic array cores; reading the destination vector of the received spike data packet; determining whether the receiving neuromorphic array core is a destination for the spike data packet based on the destination vector, and if so, sending the spike data to the receiving neuromorphic array core; and determining whether there are one or more additional destinations for the spike data packet other than the receiving neuromorphic array core based on the destination vector, and if so, (a) updating the destination vector to remove the receiving neuromorphic array core as a destination for the spike data packet if it is indicated as a destination in the destination vector, (b) determining one or more next destinations for the spike data packet based on the destination vector and a routing algorithm of the router, and (c) sending the spike data packet or a copy of the spike data packet to one or more output ports of the router based on the determined one or more next destinations.

This provides a multi-cast routing method that relieves the source neuromorphic array core of the burden of producing multiple packets, and facilitates modification of the packets at each router if the neuromorphic array core associated with the router is one of the destination nodes. The proposed approach allows the intermediary routers to forward the packets without a routing table in the router, using simple router logic and reducing latency in transmission of the spikes.

The method for routing may comprise determining only one next destination for the spike data packet based on the destination vector, and sending the spike data packet or the copy of the spike data packet to one output port based on the determined next destination. If the destination vector is updated, the updated destination vector may be included in the spike data packet or the copy of the spike data packet sent to the output port. This method may be described as a single-packet multicast method, where the single spike data packet is transmitted through neuromorphic processor without replicating the packet. This reduces congestion in the neuromorphic processor since there are not multitude of packets with the same payload and different destinations. This approach also preserves the order of spiking data as received in the destination neuromorphic array cores and uses simple router logic for low latency transmission.

Alternatively, the method for routing may further comprise deriving a plurality of new destination vectors from the destination vector when more than one next destination for the spike data packet is determined, wherein the destinations indicated in the destination vector are divided among the plurality of new destination vectors, and wherein each one of the spike data packets sent to an output port includes one of the new destination vectors. This approach further reduces latency for packet delivery due to the presence of multiple spike data packets with the same payload of spike data and different destination vectors which are created on the fly by the routers. The order to of spiking data receipt may also be preserved using a deterministic routing algorithm such as the X-Y routing algorithm.

The spike data contained in the spike data packets may indicate which neurons in the source neuromorphic array core produced a spike within a certain time period. The spike data may comprise coded data, such as binary coded data where each bit of the binary coded data indicates whether a spike is produced by a corresponding neuron during the time period. In addition, each of the spike data packets may comprise timing data indicating a time period during which the spikes were produced. The timing data may indicate a time, such as a timestamp, when the one or more spikes were produced by the one or more neurons, and can be a relative time.

The destination vector may be a destination bit vector comprising a plurality of bits, each bit indicating if a corresponding one of the neuromorphic array cores of the neuromorphic processor is a destination of the spike data packet. The position of each bit of the destination bit vector may be allocated to indicate whether a corresponding neuromorphic array core is a destination for the spiking data packet, e.g. a bit at a certain bit position may be set to “1” to indicate that the corresponding neuromorphic array core is a destination for the spiking data packet. The number of bits in the destination bit vector may be equal to the number of neuromorphic array cores in the neuromorphic processor.

The method for routing may further comprise transmitting at least a portion of the spike data to one or more neurons in the receiving neuromorphic array core based on the source identity, if the destination vector indicates that the receiving neuromorphic array core is a destination for the spike data packet. Sending the spike data to the neuromorphic array core may comprise sending the spike data packet or a copy of the spike data packet to a local output port of the router. The method may further comprise generating one or more spikes based on the spike data packet, and transmitting the one or more spikes to one or more neurons in the neuromorphic array core.

The next destination for the spiking data packet may be determined using an X-Y dimension routing algorithm, a cost function based selection algorithm, or a fixed priority based selection algorithm. Each of the spike data packets may comprise data regarding a next destination of the spike data packet in addition to the destination bit vector. This allows the router to forward the packet to a preferred destination.

In another aspect, the invention provides a router for routing spikes in a neuromorphic processor, the neuromorphic processor comprising a plurality of neuromorphic array cores each with an associated router. The router may be used in the method described herein. The router is configured to receive a spike data packet containing spike data representing one or more spikes produced by one or more neurons in a source neuromorphic array core among the plurality of neuromorphic array cores, and containing a destination vector indicating one or more destinations for the spike data packet, and a source identity indicating the source neuromorphic array core; read the destination vector of the received spike data packet; determine whether the neuromorphic array core associated with the router is a destination for the spike data packet based on the destination vector, and if so, sending the spike data to the neuromorphic array core; and determine whether there are one or more additional destinations for the spike data packet other than the neuromorphic array core based on the destination vector, and if so, (a) update the destination vector to remove the neuromorphic array core as a destination for the spike data packet if it is indicated as a destination in the destination vector; (b) determine one or more next destinations for the spike data packet based on the destination vector and a routing algorithm of the router; and (c) send the spike data packet or a copy of the spike data packet to one or more output ports of the router based on the determined one or more next destinations.

The router may be configured to determine only one next destination for the spike data packet based on the destination vector, and send the spike data packet or the copy of the spike data packet to one output port based on the determined next destination. If destination vector is updated, the updated destination vector may be included in the spike data packet or the copy of the spike data packet sent to the output port.

Alternatively, the router may be configured to derive a plurality of new destination vectors from the destination vector when more than one next destination for the spike data packet is determined, wherein the destinations indicated in the destination vector are divided among the plurality of new destination vectors, and wherein each one of the spike data packets sent to an output port includes one of the new destination vectors.

In a further aspect of the invention, an interconnect is provided for multicasting spikes in a neuromorphic processor, wherein the interconnect comprises a plurality of routers as described herein and a plurality of communication links connecting the routers. The routers are arranged in a two dimensional mesh.

In a yet further aspect of the invention, a neuromorphic processor comprising a plurality of neuromorphic array cores, each of the neuromorphic array cores comprising a spiking neural network and having an associated router, the neuromorphic processor further comprising an interconnect and routers as described herein. The neuromorphic processor maybe implemented as a single integrated circuit.

### BRIEF DESCRIPTION OF DRAWINGS

Embodiments will now be described, by way of example only, with reference to the accompanying schematic drawings in which corresponding reference symbols indicate corresponding parts, and in which:

FIG. 1 is a schematic drawing of a neuromorphic processor having a mesh topology, wherein each neuromorphic array core comprises a router;

FIG. 2 is a schematic drawing of a router according to the invention and its connections to the neuromorphic array core it is assigned, or to other routers of the neuromorphic array;

FIG. 3 is a schematic overview of a routing technique, specifically unicast-based multicast communication as is known in the art;

FIG. 4 is a schematic overview of a routing technique, specifically single-packet multicast communication;

FIG. 5 is a schematic drawing of a spike routing concept for a router for single packet multicast communication;

FIG. 6 is a flowchart describing a single packet multicast communication method;

FIG. 7 is a flowchart describing the address modifier method;

FIG. 8 a schematic overview of a routing technique, specifically multi-packet chain reaction multicast communication;

FIG. 9 is a schematic drawing of a spike routing concept for a router for multi-packet multicast communication;

FIG. 10 is a schematic drawing of a flow chart describing a multi-packet multicast communication method; and

FIG. 11 is a schematic drawing of a flow chart describing a destination vector split algorithm.

### DESCRIPTION OF EMBODIMENTS

Hereinafter, certain embodiments will be described in further detail. It should be appreciated, however, that these embodiments may not be construed as limiting the scope of protection for the present disclosure.

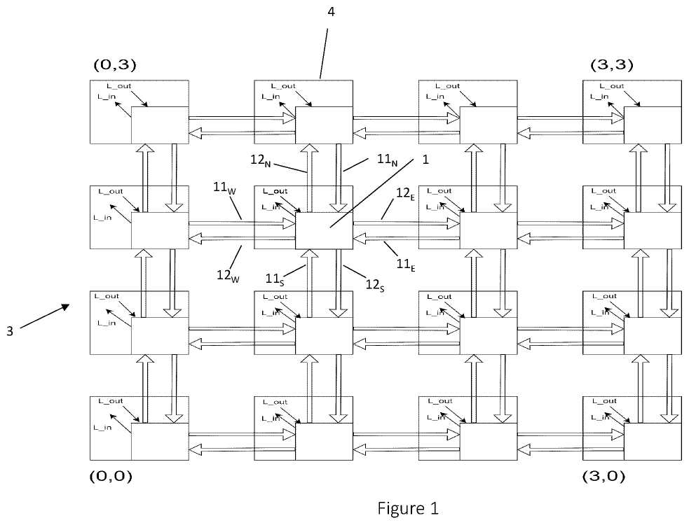

FIG. 1 is a schematic drawing of a neuromorphic processor comprising a neuromorphic array divided into multiple neuromorphic array cores interconnected in a 2D mesh topology, wherein each neuromorphic array core 4 has a router 1. Other topologies can also be used and fall within the invention. The router 1 and the core 4 together form a node of the neuromorphic array. Each core may comprise a programmable network of spiking neurons and synapses. Each router 1 can be used for inter-node communication.

An ensemble is a sub-network of neurons that form a co-operative group which can for example form a classifier, an ensemble of classifiers, groups of neurons that handle data conversion, feature encoding or solely the classification, et cetera.

A network of ensembles can be partitioned and mapped onto the array of cores. Each core consequently implements a single ensemble, multiple small ensembles (in relation to the number of neurons and synapses in the core), or in the case of large ensembles, only a part of a single ensemble, with other parts implemented on other cores of the array. The modalities of how ensembles are partitioned and mapped to cores can be determined by a mapping methodology which is outside the scope of the present invention.

Each core thus comprises (at least a part of) a spiking neural network, comprising one or multiple neurons and one or multiple synapses (also called synaptic elements). The neurons and synapses are at least partly, or completely implemented in hardware. The neurons 1 and synaptic elements 2 can be implemented in hardware, for example using analog circuit elements or digital hardwired logic circuits. They can also be implemented partly in hardware and partly in software. Implementation in hardware or at least partly in hardware is preferred, i.e., a hardware circuit or element is used to perform the functions of the individual neurons, rather than using a large processor executing software where the software mimics individual neurons. These (part) hardware implementations achieve faster processing, e.g., enabling much faster pattern recognition, and event-driven processing in which blocks of neurons and synaptic elements are only activated when needed.

A typical router 1 can have for example five input ports and five output ports. A port can be local, i.e., between the router 1 of a node 4 and a different hardware structure within that node 4 (for example towards the spiking neural network formed in the core of the node); or a port can be non-local, i.e., between routers 1 of different nodes 4. The number of input ports and output ports may be the same or may be different.

Shown in the present embodiment are one local input port (L_in) and one local output port (L_out) per node. Furthermore, the four non-local input ports shown are a north, south, west and east input port N_in, S_in, W_in and E_in. The name of each input port indicates the direction to a node within the mesh from where the input signal (11_{N,S,W,E}) arrives. The four non-local output ports shown are a north, south, west and east output port, indicated by N_out, S_out, W_out and E_out respectively. Also for the output ports, the name of each output port indicates the direction to a node within the mesh to where the output signal (12_{N,S,W,E}) is sent.

The mesh in this embodiment has a total of 16 nodes, but more or less nodes can also be envisioned. The routers at the edges of the mesh may have less than four non-local input and output ports in use. For example, the router located in the node in the southeast corner of the mesh may only need input/output to both the north and west. The shown exemplary mesh is a 2D mesh, but 1D or 3D meshes linked in a similar way can also be envisioned. While the shown exemplary mesh only shows connections between adjacent nodes, it is envisioned that routers may also be connected to diagonally adjacent nodes, or to certain nodes which are not directly adjacent.

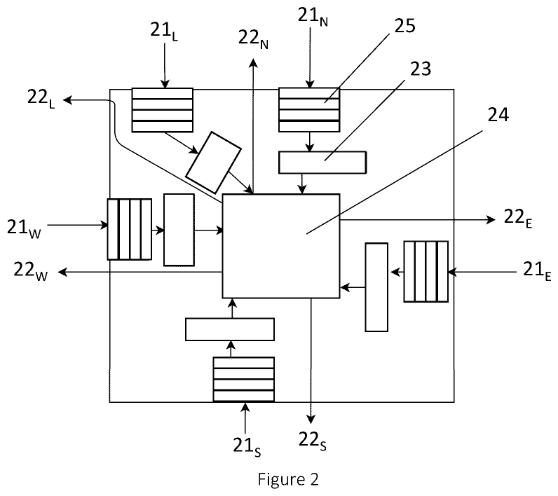

FIG. 2 is a schematic drawing of a router according to the invention and its input and output ports from and to the different routers within a mesh. It provides a more detailed overview of e.g., one or multiple of the routers 1 shown in FIG. 1.

The local input port 22L, as well as the local output port 21L as shown. As mentioned, these arrange for communication between the router and the other parts of the node to which the router is assigned. The non-local input 21_{N,S,WE} and output 22_{N,S,W,E} ports arrange the communication to and from other routers within the mesh.

Signals arriving to the router may pass through a buffer 25. A buffer is a block of memory which may handle data, for example spike packets, during the network routing process. As data flows through different nodes of the network, different rates of transmission occur between the routers, which can create network congestion. A buffer 25 compensates for variations in speed and temporarily stores (e.g., spike) packets to address high-volume bursts during data transmission. Next, the arriving signal may go through a control logic point 23. The control logic point 23 can read data in the spike packet, decides whether the spike packet needs to be sent onwards or absorbed by the node, and the control logic point can also include the routing algorithm module which applies the routing algorithm whether the spike packet is sent through to the local port, and/or the non-local port and the calculation of the next destination. The control logic point can also modify information in the spike packet, as will be described below with respect to the destination vector for example. The control logic point can also control flow from the buffer to the crossbar. For example, multiple spike packets can be kept in the buffer of the router until they are sent onwards. Next, the arriving signal (which may be adapted) reaches the crossbar 24, which redirects the input 21 to an output 22 which may be a local output or a non-local output. The crossbar 24 configures the connections between the input ports and the output ports to establish the desired path for each packet.

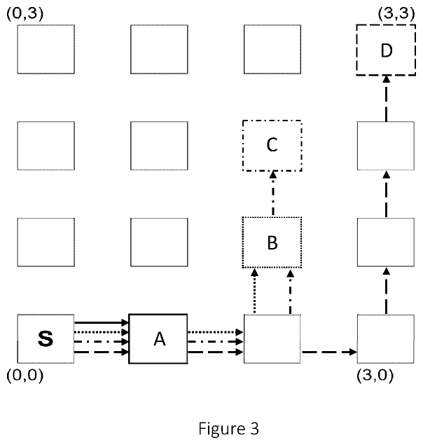

FIG. 3 is a schematic overview of a known unicast based multicast communication. The nodes (cores) are arranged in a mesh topology. Each square box in FIG. 3 represents a neuromorphic array core (node) with a router. For sending a spike packet to four destinations (A, B, C and D) from the source node S, this approach requires four independent spike packets to be sent, one to each destination. These spike packets are visualized by the four different arrow types. Each spike packet comprises of spike data and an address of the destination node (A, B, C or D) for which the spike packet (SP) is intended, and has the general form of SP=[<spike_data>,<destination_node_address>], which results in the following spike packets:

1) SP1 = [<spike_data>,<destination_node_address(A)>];
2) SP2 = [<spike_data>,<destination_node_address(B)>];
3) SP3 = [<spike_data>,<destination_node_address(C)>];
4) SP4 = [<spike_data>,<destination_node_address(D)>].

In FIG. 3, each arrow from source node S is a spike packet, and each packet can be sent either sequentially or in parallel through the E_out port following the XY dimension routing algorithm. In this approach, multicast is implemented on multiple unicast packets. This approach creates a lot of packets in the interconnect and may lead to congestion. Furthermore, the spike data may be the same for all spike packets SP1 to SP4, leading to an unnecessary amount of copies of the same data. The disadvantages of the multipacket unicast method are overcome in the current invention with the use of a single-packet multicast communication detailed below.

Other forms of multicast communication other than unicast-based communication are path-based and tree-based multicast communication.

In path-based communication, the spike packet is forwarded to each destination sequentially following one path which is determined by the routing algorithm. In tree-based communication, the source node is seen as the root of the tree, the packet is sent down the tree, and the spike packet may be replicated at the branches for a single set of destination nodes when required. The methods of the present invention are path- and tree-based multicast communication. These will be explained below.

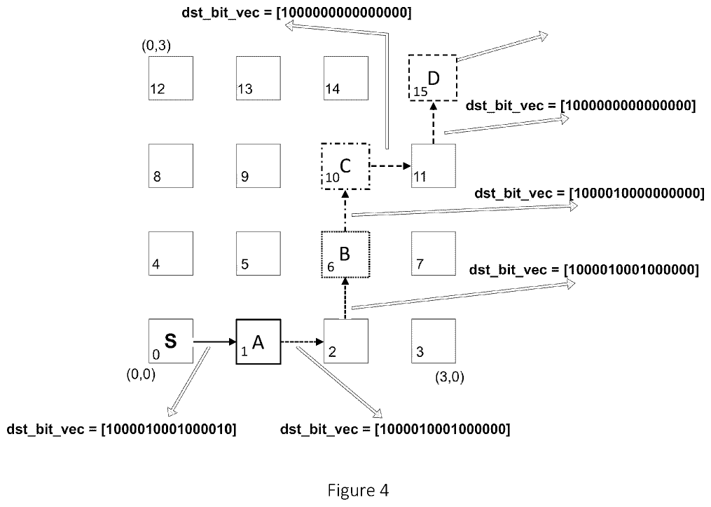

FIG. 4 is a schematic overview of single-packet multicast communication. In this proposed method, for sending identical spike data to four different destination nodes, a destination bit vector (DBV) is employed. The destination bit vector may be a vector of length equal to the number of nodes in the network. In this example the number of nodes is 16, hence the DBV is 16 bits in width. Each bit position in the DBV represents the node/router ID. The node identified with letter S is the source node in the present example, while A, B, C and D indicate destination nodes. Only one SP is sent in this approach: Spike Packet (SP)=[<spike_data>,<destination_bit_vector>,<next_destination>]. Note that the next destination field is optional, it might be necessary for particular routing algorithms.

In this particular example, the source node S sets the destination bit vector as [1000010001000010] and the next destination as node A. The packet comprising of spike data and the destination bit vector is routed according to the XY-dimension routing algorithm in every router and it takes the following path. First the packet goes to Node A, where the spike data is copied and absorbed, and the destination bit vector and next destination fields are modified. Next, the packet is transmitted to the next router according to the XY-dimension routing algorithm. This procedure is followed at all the listed destination nodes. When the packet reaches the last node, in this case, the node D, the packet is routed to the local port and not transmitted further to the next router.

If a particular bit position is set to 1 in the DBV, it indicates that the node ID equal to the bit position is one of the destinations of the packet. In this example, the node/router ID of node A is 1 and it is one of the destinations of the spike data. When the packet reaches node A, the bit position 1 is cleared, i.e., set to 0 after the packet is replicated and the original is absorbed. This approach is followed by every destination node, until the final destination node D, where the packet is not replicated, but just absorbed.

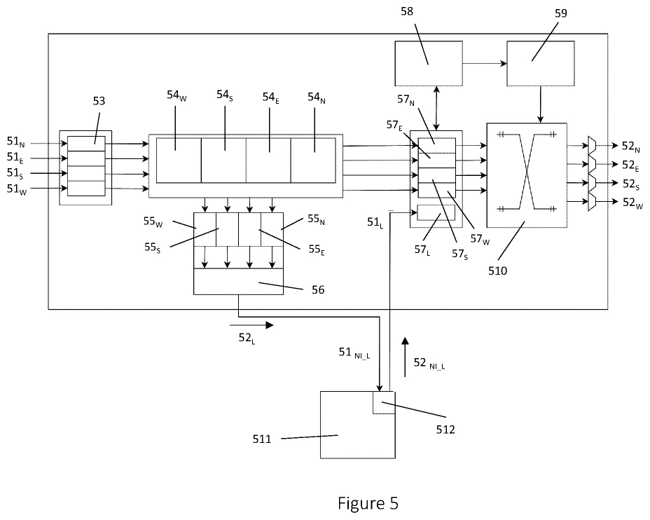

This method allows the spike to be replicated by intermediary destination nodes, thus relieving the burden of producing multiple packets by the source node. This method also facilitates the modification of the packet at each input port if the current node is one of the destination nodes. The proposed approach allows the intermediary nodes to forward the packet without a routing table in the router. It also reduces the congestion in the network since there are no multitude of packets with identical payload and different destination IDs. Not only may this approach preserve the spikes ordering in the destination nodes, but also the DBV allows us to create a simple router logic. The latter reduces the latency in transmission of spikes. In order to implement such a spike multicast technique, a spike routing concept can be used as shown in FIG. 5.

FIG. 5 is a schematic drawing of a spike routing concept for a router for single packet multicast communication. The network interface block 512 of the neuromorphic array 511 is responsible for deciding the destination address/ID for the packet. The address modifier block 54 is responsible for modifying the destination bit vector.

The packet is received from one of the N_in, S_in, W_in and E_in non-local input ports (51_{N,S,W,E}) which are connected to the other routers in the mesh. The packet may be passed through a buffer 53, which is, amongst other things, able to temporarily store the incoming packet in case of congestion or other reasons. After passing through the buffer 53, the packet may reach an address modifier block 54. The address modifier block can have subblocks 54_{N,S,W,E} for each of these ports 51_{N,S,W,E}, which act on packets received through their corresponding ports. There can also be a single address modifier block which acts on received packets through all input ports. The address modifier block checks if the packet's final destination node is the current node. If yes, the packet may be absorbed and no copy of the packet is made. If the node is not the final destination, but one of the destinations, a copy of the packet can be made and the destination bit vector of the copied packet is modified by clearing the bit position corresponding to the current node address/ID. The original packet is absorbed, and the copy is transmitted to the next router according to the routing algorithm.

This is shown in FIG. 4, where the input spike packet to node A has destination bit vector equal to [1000010001000010]. The spike packet is replicated by the router in node A and the address modifier block of the router in node A modifies the destination bit vector to [1000010001000000]. I.e., the destination bit vector is modified in such a way that node A is no longer indicated as a destination of the spike packet by the destination bit vector. The original packet payload may be routed to the local port of the router in node A.

If the current node is not a destination, the packet may be transmitted onwards to the next node according to the routing algorithm without changing the destination bit vector of the spike packet.

The absorption of the original packet may happen via the following steps. First the signals from the address modifier block of each of the ports (54_{N,S,W,E}) may pass through individual buffers 55_{N,S,W,E} to the arbiter 56. The arbiter 56 can generate one single output from all of these inputs, or the spike data from all inputs are kept separately. The output of the arbiter is called the local output 52L. The local output enters the network interface block 512 of the neuromorphic array 511 as a network interface local input 51_{NI_L}. The network interface local input 51_{NI_L} then may arrive at the neuromorphic array 511 and can be used as spike input to the neuromorphic array.

The network interface local input 51_{NI_L} may indicate, for example according to the spike data, which one or multiple synapses of the neuromorphic array the spikes represented by the spike data need to reach. For example, the spike data could indicate from which one or multiple neurons in e.g., the source node S the spikes represented by the spike data originate. The spike data could additionally or alternatively indicate one or multiple target synapses or neurons in the neuromorphic array 511 the one or multiple spikes represented by the spike data need to affect.

The neuromorphic array core 511 may have neurons which create spatio-temperal spike trains, for which (at least a part of) the spike data needs to be sent to a neuron or synapse in a different node. This may result from the spikes represented by the network interface local input 51_{NI_L} but could also have other causes. The neuromorphic array thus outputs spikes or spike data, with which the network interface block 512 may generate network interface local output 52_{NI_L} which enters the router as local input 51L. This local input 51L contains information about the destination address/ID for the data-packet, which may be generated by the neuromorphic array or by the network interface.

The next destination field in the spike packet may be calculated using different methods. A first method may be a cost function-based destination selection. In this method, the total hops for each of the destination nodes is calculated and the next destination can be decided using one of several ways, for example by (a) selecting the destination corresponding to the least number of hops as the next destination, or (b) selecting the destination corresponding to the most number of hops as the next destination. A second method may be a fixed-priority-based destination selection. Each destination bit vector bit position can be given a priority. If a bit position in the destination bit vector is set to 1, this can imply that the node having an ID/address corresponding to the BIT position is one of the destinations. Of these destinations, the next destination can be selected based on the priority.

The input 51L and the outputs from 54_{N,S,WE} can all be temporarily stored in respective buffers 57_{L,N,S,W,E}. The routing algorithm 58 uses the information in the buffers 57 to determine the next hop on the path the data packet should take to reach its destination.

The routing decision is then communicated to the switch allocator 59, which takes into account available resources and schedules the packet for transmission on a particular output port (52_{N,S,W,E}). The switch allocator relays this information to crossbar 510. Crossbar 510 configures the appropriate connections between the buffers 57_{N,S,W,E} and output ports 52_{N,S,W,E} to establish the desired path for the packet. The packet is then forwarded through the crossbar to the output ports 52_{N,S,W,E} where it can be forwarded to the next router. The crossbar can also alternatively be used to send spike data to the neuromorphic array via the local input port.

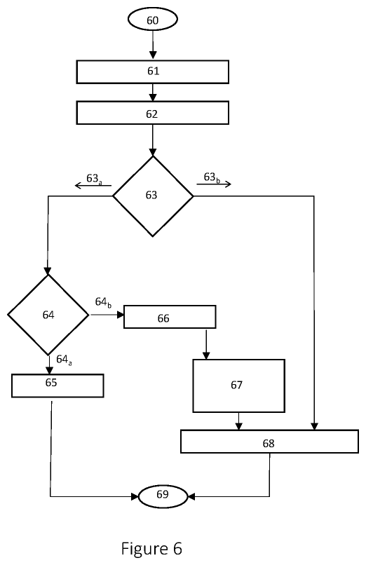

FIG. 6 is a schematic drawing of a flow-chart following one way of conducting the single packet multicast communication method. The flow-chart begins at start 60. At step 61, one or multiple spike packets may be collected from one or more input ports at one or more nodes. At step 62, the node address/ID of the node where the spike packet was collected, and the destination bit vector of the spike packet collected at the node are obtained.

In step 63, it is then determined whether the node address/ID is present in the destination bit vector. For example, if the bit in the destination bit vector that relates to the node is set to a particular value.

If the node address/ID is not present in the destination bit vector, route 63b is followed to step 68, where the spike packet is routed according to the routing algorithm without it being necessary to absorb the spike data at the node. Then, at step 69 the flow chart for this iteration of the single packet multicast communication method ends.

If, on the other hand, the node address/ID is present in the destination bit vector, route 63a is followed to step 64 where it is checked whether this node is the final destination node.

If the node is the final destination node (node D in FIG. 4), route 64a is followed and the spike packet/payload is absorbed through the local port at step 65, and at 69 the flow chart ends.

If the node is not the final destination node, route 64b is followed to step 66 where a copy of the spike packet is created. Either the original or the copy of the spike packet is subsequently absorbed through the local port. At step 67, either the copy or the original of the spike packet respectively is then taken and the next destination of this spike packet is then decided depending on the preferred destination, using the destination selection methods discussed above.

The packet is consequently routed according to the routing algorithm at 68. It is also possible that the copying of the spike packet happens after the payload is absorbed/ejected through the local port, for example at the network interface.

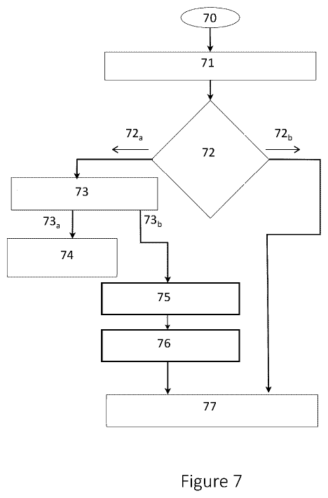

FIG. 7 is a schematic drawing of a flow-chart following one way of conducting the address modifier method. After start 70, the method at step 71 requires the node address/ID of the node at which a spike packet arrives and the destination bit vector for that spike packet to be obtained.

At step 72, it is checked whether the current node address/ID position in the destination bit vector is set to a particular value, for example to 1.

If the current node address/ID position in the destination bit vector is not set to the particular value, this means that the node is not a destination of the spike packet and route 72b is followed to step 77, where the packet is routed according to the routing algorithm.

If, however, the current node address/ID position in the destination bit vector is set to the particular value, route 72a is followed to step 73. At step 73 the payload is replicated, resulting in two payloads: an original and a replica. Either the original or the replica payload follows route 73a to step 74 where the payload is absorbed through the local port. The replica or the original payload respectively follows route 73b to step 75 where the current node ID position in the destination bit vector is set to 0. Then, at step 76, the next destination field value is decided depending on the next preferred destination, using the destination selection method. Hereafter, at step 77, the packet is routed according to the routing algorithm.

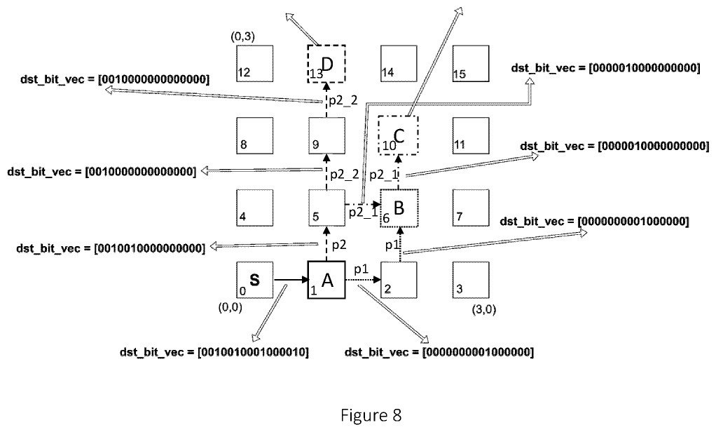

FIG. 8 a schematic overview of a Multi-Packet Chain-Reaction Multicast communication. In this proposed method, to send the packet to M destinations, an intermediate node replicates the packet during routing and creates up to (M−1) new packets each with a different destination bit vector and next destination field value. For a network of N nodes, for example a destination bit vector is employed of length equal to the number of nodes in the network. In this case, for example each bit position in the destination bit vector represents the node or router address/ID. In this particular embodiment there are M=4 destinations and N=16. In order to send the spike data to 4 destinations, the source node sends one packet and, when appropriate, the intermediary node splits the destination vector into two vectors. The intermediate nodes may replicate the packet and create one or more new packets with different destination bit vectors and next destination field values. In this example at node A only one replica of the original packet is made, and thus two spike packets are eventually sent from node A comprising at least the original spike data.

FIG. 8 displays the proposed method with node S as source node and A, B, C, D as destination nodes. In this approach only one spike packet is sent from the source node: Spike Packet (SP)=[<spike_data>,<destination_bit_vector>,<next_destination>]. Again, the next destination field is optional.

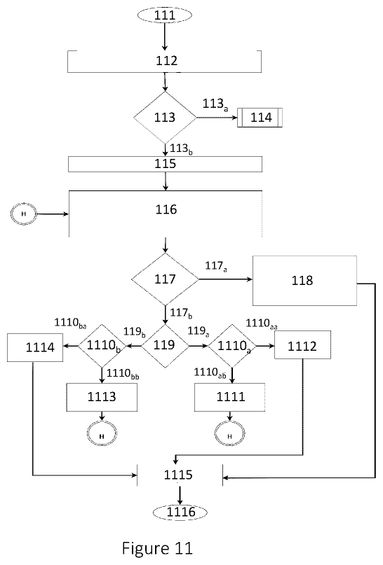

The source node S creates a spike packet with the destination bit vector as [1000010001000010], thus SP=[<spike_data>,<1000010001000010>,<node A>]. The spike packet can then be routed for example according to the XY-Routing algorithm, and it takes the following path. When the packet goes to node A, the spike data comprised in the spike_data field is absorbed since node A is a destination node of the spike packet. The absorption may occur according to the description above. Next, according to the destination vector split (DVS) method (further disclosed with respect to FIG. 11), the packet may be replicated and the destination bit vector is modified, and the packet is passed along according to the XY-routing algorithm. Note that the packet may be replicated before or after the packet is absorbed at the node. At node A, two packets are thus created/modified with different destination bit vectors, one packet (p1) is designated for node B and the other (p2) for C and D.

The spike packet p1 is routed according to the XY algorithm to node B. At node number 2, the packet does not have to be replicated since there is only one destination in the destination bit vector. Furthermore, at node 2 the packet does not have to be absorbed since it is not a destination node.

The spike packet p2 is routed to node number 5 according to the XY algorithm. At this node 5, the packet is replicated, and the destination bit vector is changed according to the destination vector split method. The new packet p2_1 is routed to node C and the other new packet p2_2 is routed to the destination D. At nodes number 6 and 9 the spike packets are not replicated since there is only one destination in the DVB. Upon reaching the final destination of each packet, the packet is absorbed and not replicated further.

FIG. 8 shows the node or router ID/address for all node/routers with a number between 0 and 15. A bit position in the destination bit vector can indicate the router ID. If the value of a particular bit position is set to “1” in the destination bit vector, it indicates that the node ID equal to the bit position is one of the destinations of the packet.

In this example, the node or router ID/address of node A is 1 and it is one of the destinations. When the packet reaches the node A, the bit position 1 is cleared, i.e., set to 0 before or after the packet is replicated into two copies and the original is absorbed. The next destination in each of the new spike packets is set according to one of the destination selection methods (DSM). This approach is followed by every intermediary destination node, until the final destination nodes for each spike packet, where the packet is not replicated, but just routed through the local input port and not forwarded further.

As mentioned, the spike packet can also be replicated into two or more copies. Whether the spike packet needs to be replicated and the destination bit vector split between destinations may depend on the routing algorithm used. For example, in a particular XY-routing algorithm, if multiple destinations are present within the same row a split may occur. Other ways of determining whether a split needs to occur are also within the scope of the present invention. Depending on whether the node is a destination node, the original is absorbed or not.

The proposed method allows the spike packet to be replicated by intermediary nodes, thus relieving the burden of producing multiple packets by the source node. Furthermore. the method also facilitates the modification of the packet at each input port if the current node is one of the intermediary nodes and the destination bit vector for example has more than one destination bit set.

The proposed method further allows the intermediary nodes to forward the packet without a routing table in the router. This approach reduces the latency for packet delivery in the network due to the presence of a multitude of packets with identical payload and different destination IDs which are created on the fly in the network. This approach preserves the ordering of the spikes (which form the basis for the spike packets) in the destination nodes following the deterministic routing algorithm like the X-Y algorithm.

Also. the destination bit vector allows for the creation of a simple router logic thus reducing the latency in transmission of spikes. The next destination field allows the router to forward the packet to a preferred next destination.

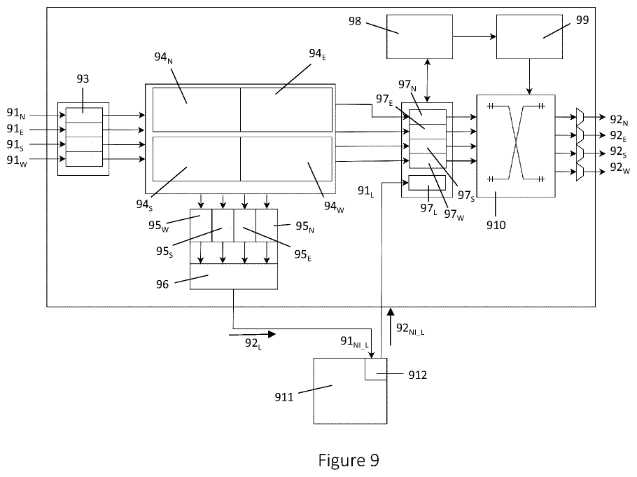

FIG. 9 is a schematic drawing of a spike routing concept for a router for multi-packet multicast communication. The embodiment in FIG. 9 is similar to the one in FIG. 5, similar parts will not be explicitly mentioned. The main difference between the embodiments is that the embodiment of FIG. 9 comprises a destination vector split (DVS) block 94, which is responsible for modifying the destination bit vector.

The packet is received from the N_in, S_in, W_in and E_in non-local input ports (91_{N,S,W,E}) which are connected to other routers in the mesh. The spike packet may then be passed through a buffer 93, which is able, among other things, to temporarily store the incoming packet in case of congestion or other reasons. Each port may have its own dedicated buffer. After passing through buffer 93, the packet may reach DVS block 94. The DVS block 94 can be a single functional module, or can be subdivided into blocks (94_{N,S,W,E}) for each of the non-local input ports. The DVS block 94 can check if the packet's final destination node is the current node. If yes, the packet is absorbed, and no copies of the packet are created.

If the node is not the final destination, but one of the intermediary destination nodes, two or more copies of the packet are made, and the destination bit vector and next destination fields of these replica packets are modified by clearing the bit position corresponding to the current node ID/address and setting the next destination using the destination selection method (DSM) accordingly. The original packet is absorbed, and the replicas are transmitted to the next router according to the routing algorithm.

The absorption of the original packet and the transmission of the replicas according to the routing algorithm happens in a similar fashion to FIG. 5. The absorption and transmissions are also visualised in FIG. 8, the input packet to node A has destination bit vector equal to [0010010001000010], the two new packets, p1 and p2 have destination bit vectors [0000000001000000] and [0010010000000000] respectively, and the original packet payload is routed to the local input port of the router in node A. If the current node is a final destination, the packet is not transmitted further, if not the packet is transmitted according to the routing algorithm. This procedure is repeated for all the intermediary nodes of the spike packet.

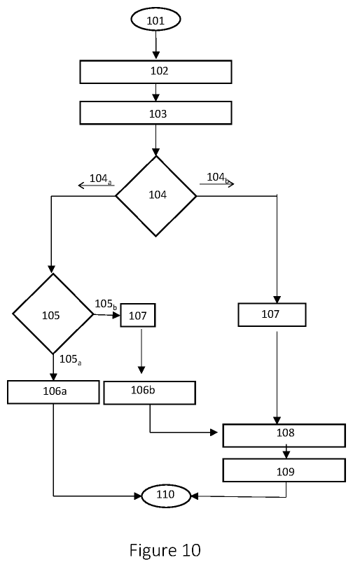

FIG. 10 is a schematic drawing of a flow chart describing the multi-packet multicast communication method. After start 101, at step 102 a spike packet may be collected collect from an input port at a particular node, and the node address/ID and the destination bit vector are obtained for the spike packet in the node at 103. Next, in step 104 a comparison is made whether the node address/ID is present in the destination bit vector, for example by an indicated value of “1” in the destination bit vector.

If the node address/ID is not present in the destination bit vector, route 104b is followed to step 107 where one or more copies of the packet can be created with different destination bit vector according to the destination vector split (DVS) algorithm, if necessary. At step 108, the next destination may be decided depending on the preferred destination, using a destination selection method. The spike packet can be consequently routed according to the routing algorithm at 109. At step 110 the method ends.

If the node address/ID is present in the destination bit vector, route 104a is followed to step 105 where it is checked whether the particular node is the final destination node. If the node is the final destination node, route 105a can be followed and the packet/payload is absorbed/ejected through the local port at step 106a and at 110 the method ends. If the node is not the final destination node, route 105b is followed to step 107 where one or more copies of the packet can be created with different destination bit vector according to the destination vector split (DVS) algorithm. Next, at step 106b, the (original) packet/payload may be absorbed/ejected through the local port. Next, at step 108 the next destination of the copies may be decided depending on the preferred destination, using a destination selection method. The copied spike packets may be consequently routed according to the routing algorithm 109 and at step 110 the method ends. It is also possible that the copying of the packet happens after the payload is absorbed/ejected through the local port, meaning that 106a/106b would come before 105 in the method.

FIG. 11 is a schematic drawing of a flow chart describing the destination vector split algorithm. The flow chart begins at the top at the start 111. At step 112 every input packet with N-bit destination bit vector are obtained. In step 113, it is checked whether the processing of the previous spike packet has completed.

If the processing of the previous spike packet has not been completed, route 113b is followed to step 114 where the method waits until the processing has been completed.

If however the routing has been completed, route 113a is followed to step 115 where the new spike packet is processed. After processing the packet's destination bit vector of length N bits, the packet is divided at step 116 into two DBVs in the middle of the original DBV: A and B, such that DBV A=DBV [N/2:0], DBV B=DBV [N−1: (N/2)+1]. An example of this division is provided in FIG. 8 for the DBV [0010010001000010], with N=16. This DBV is split into DBV A which contains the first half of the digits ([8:0]) DBV A=[00100100] and DBV B which contains the second half of the digits ([15:9]) DBV B=[01000000]. Note that the bit position corresponding to node A was cleared, i.e., set to 0, because the node where the split occurred was node A and the spike packet had thus already arrived at destination A in FIG. 8 when this split occurred.

In the step 117 it is checked whether both DBV A and DBV B are not equal to zero. If they are not equal to zero route 117a is followed to 118 where two replica spike packets are created with A and B as destination bit vectors, wherein A and B may have been zero appended vectors, such that these destination bit vectors have for example original length equal to the amount of nodes in the mesh again. Thus, DBV A=[0010010000000000] and DBV B=[0000000001000000] in the case of FIG. 8, and the splitting of the packet is completed at 1115.

If either DBV A or DBV is equal to zero route 117b is followed to step 119. At step 119 it is checked whether DBV A is equal to zero. If DBV A only contains zeroes, route 119a is followed to step 1110a where it is checked whether N is equal to 1. If N is not equal to 1 route 1110aa is followed to step 1112 where the destination bit vector is set to DBV B and N is set to N/2 (since this is the length of DVB B), and the flow chart is then walked through again starting from step 116, but with DVB B instead of the original destination bit vector. If N is equal to 1 no further division can be made route 1110ab is followed to step 1111 where a replica spike packet with new DBV B is sent out, if necessary appended with zeroes.

If DVB A does not only contain zeroes, that means DVB B contains only zeroes. Route 119b is then followed to step 1110b where it is checked whether N is equal to 1. If N is not equal to 1 route 1110ba is followed to step 1113 where the destination bit vector is set to DBV A and N is set to N/2 (since this is the length of DVB A). The flow chart is then walked through again starting from step 116, but with DVB A instead of the original destination bit vector. If N is equal to 1 no further division can be made route 1110bb is followed to step 1114 where a replica packet with new DBV A (if necessary appended with zeroes) is sent out.

Note that in all examples above, a destination neuron within a destination node can be agnostic of the spike ordering and the time difference between different spikes arriving, as long as the time difference is less than (at least a particular fraction of) the decay period of the neuron. Since the decay period of a neuron is generally programmable, the amount in which a destination neuron is agnostic to the spike ordering can be tuned to some degree.

Note that in all examples above, at each source node, one can encode the spikes in a binary format (e.g., a bit vector indicating which of the neurons within the source node has spiked) along with optionally a time stamp of the spike/set of spikes at which moment the spike occurred. This can be a relative time, for example with respect to a previous spike. This can be inputted into the spike data field of the spike packet. The spike packet can thus contain information of a single spike of a single neuron within the source node, but it can also contain information of the spike of a group of neurons or all neurons within the source node.

This can be implemented by detecting the spike or spikes at the source node and optionally taking a snapshot of the timer value and thereafter restarting the timer. Thereafter, the detected spike can be encoded in a representation, for example a binary representation as mentioned above where a bit vector indicates for each bit position whether a neuron fired or not. This encoded data, optionally together with the time stamp can then be placed in the spike packet as spike data. The spike data may also comprise other information on the spike that occurred.

The spike packet in all embodiments, may together with the spike data also contain a source node or source router address/ID. Furthermore, as mentioned a destination bit vector can be included which encodes the destination node addresses/IDs.

While in the foregoing a destination bit vector was used, more generally the disclosed methods can make use of a destination vector, which carries information on the intended recipients of the spike packet, e.g., the intended router, node or neuron(s). The destination vector can encode the destination nodes in bits by setting “0”s to “1”s in the destination bit vector at a bit location corresponding to the address/ID of a particular node or router. However, other ways of encoding such information are also envisioned. For example, the destination vector can be a list of node or router addresses or IDs. The destination vector can also indicate specific destination neurons, and the router may check whether such a destination neuron is present in the neuromorphic array core connected to the router. The destination vector could also indicate the source neuron, and each router can check whether there are neurons in the neuromorphic array core connected to that router which should receive the corresponding spike data as a result of such a source neuron firing.

Optionally, apart from the spike data, the source node ID and the destination vector, the spike packet may further contain a next destination field, although this is not required. The next destination field value may be required depending on a particular routing algorithm. For example, static or dynamic routing may be used and depending on the routing algorithm a next destination field value is required. Although the embodiments above showed spike packets with a next destination field, this value is thus not required to perform the invention but is only optional.

In general, dynamic routing may be used to take into account data traffic in between cores in the mesh, and to route packets through routers which are less busy. The routing algorithm then takes into account the data load on each router, and updates the next destination field, for example after each hop between routers in the mesh.

In all described embodiments, within a destination node a source ID decoder can be present. The source ID decoder decodes the source node ID information present in the spike packet. Based on the decoded source ID, the destination node can decide which presynapse or set of presynapses will receive the incoming spikes/set of spikes. A lookup table can be used to match the decoded source ID with the intended destination presynapse or presynapses.

It is possible to decode on the level of every presynapse, however this will result in a larger lookup table which consumes more on chip area. In a preferred embodiment, the decoded source ID is matched to a particular group of presynapses. For example, each node comprises 32 neurons and 128 presynapses that connect to the 32 neurons. The information on which of the 32 neurons spiked is encoded the spike data which is encapsulated in a spike packet, and after routing the spike packet to a destination node, a destination group of for example 32 presynapses can be selected by matching the decoded source node ID via the lookup table. In this example, the destination node has thus four groups of 32 presynapses which can be matched to the decoded source node ID via the lookup table. An arbitrary number of presynapses, neurons, groups of presynapses can be used. Furthermore, multiple layers of neurons and synapses can be used within the same core.

In general, for every incoming packet, the encoded spike data in the packet can be decoded and the presynapse data can be formed on the basis of the decoded spike data. This presynapse data can then be send in parallel (i.e., at the same time) to the presynapse. The spikes going in may be digital pulses (for example, an edge detector circuit). The presented network-on-chip design is independent of whether the neuromorphic arrays are analog or digital arrays. For digital arrays, spikes can represented as bit values, and standard multiplier accumulator modules within the presynapses then apply a weight to the spike.

The invention thus discloses a mesh of neuromorphic array nodes, each with their own router. The invention sees on the routing techniques used between these routers. The inventive idea in general of the inventors was to use spike packets. These spike packets in general comprise spike data and a destination vector. The spike packet may indicate the source node ID from where the spike data originated. The spike data carries spike information on either a single neuron within the source node, or a group of neurons within the source node. Either the destination routers have information to map the spike data to the correct part of the neuromorphic array comprised within their related neuromorphic array core, or the spike packet comprises this information.

Any of the embodiments disclosed above may be combined in any appropriate manner.

1. A method for routing spikes in a neuromorphic processor, the neuromorphic processor comprising a plurality of neuromorphic array cores each with an associated router, the method comprising:
generating spike data representing one or more spikes produced by one or more neurons in a source neuromorphic array core among the plurality of neuromorphic array cores;
generating a spike data packet containing the spike data, a destination vector indicating one or more destinations for the spike data packet, and a source identity indicating the source neuromorphic array core;
transmitting the spike data packet to one or more of the routers of the neuromorphic processor;
receiving the spike data packet in a router of a receiving neuromorphic array core among the plurality of neuromorphic array cores;
reading the destination vector of the received spike data packet;
determining whether the receiving neuromorphic array core is a destination for the spike data packet based on the destination vector, and if so, sending the spike data to the receiving neuromorphic array core; and
determining whether there are one or more additional destinations for the spike data packet other than the receiving neuromorphic array core based on the destination vector, and if so,
(a) updating the destination vector to remove the receiving neuromorphic array core as a destination for the spike data packet if it is indicated as a destination in the destination vector;
(b) determining one or more next destinations for the spike data packet based on the destination vector and a routing algorithm of the router; and
(c) sending the spike data packet or a copy of the spike data packet to one or more output ports of the router based on the determined one or more next destinations.

2. The method of claim 1, wherein only one next destination for the spike data packet is determined based on the destination vector, and the spike data packet or the copy of the spike data packet is sent to one output port based on the determined next destination.

3. The method of claim 2, wherein, if destination vector is updated, the updated destination vector is included in the spike data packet or the copy of the spike data packet sent to the output port.

4. The method of claim 1, further comprising deriving a plurality of new destination vectors from the destination vector when more than one next destination for the spike data packet is determined, wherein the destinations indicated in the destination vector are divided among the plurality of new destination vectors, and wherein each one of the spike data packets sent to an output port includes one of the new destination vectors.

5. The method of claim 1, wherein the spike data contained in the spike data packets indicates which neurons in the source neuromorphic array core produced a spike within a certain time period.

6. The method of claim 1, wherein each of the spike data packets comprise timing data indicating a time period during which the spikes were produced.

7. The method of claim 1, wherein the destination vector is a destination bit vector comprising a plurality of bits, each bit indicating if a corresponding one of the neuromorphic array cores of the neuromorphic processor is a destination of the spike data packet.

8. The method of claim 1, further comprising, if the destination vector indicates that the receiving neuromorphic array core is a destination for the spike data packet, transmitting at least a portion of the spike data to one or more neurons in the receiving neuromorphic array core based on the source identity.

9. The method of claim 1, wherein each of the spike data packets comprises data regarding a next destination of the spike data packet in addition to the destination bit vector.

10. A router for routing spikes in a neuromorphic processor, the neuromorphic processor comprising a plurality of neuromorphic array cores each with an associated router, the router configured to:
receive a spike data packet containing spike data representing one or more spikes produced by one or more neurons in a source neuromorphic array core among the plurality of neuromorphic array cores, and containing a destination vector indicating one or more destinations for the spike data packet, and a source identity indicating the source neuromorphic array core;
read the destination vector of the received spike data packet;
determine whether the neuromorphic array core associated with the router is a destination for the spike data packet based on the destination vector, and if so, sending the spike data to the neuromorphic array core; and
determine whether there are one or more additional destinations for the spike data packet other than the neuromorphic array core based on the destination vector, and if so,
(a) update the destination vector to remove the neuromorphic array core as a destination for the spike data packet if it is indicated as a destination in the destination vector;
(b) determine one or more next destinations for the spike data packet based on the destination vector and a routing algorithm of the router; and
(c) send the spike data packet or a copy of the spike data packet to one or more output ports of the router based on the determined one or more next destinations.

11. The router of claim 10, wherein only one next destination for the spike data packet is determined based on the destination vector, and the spike data packet or the copy of the spike data packet is sent to one output port based on the determined next destination.

12. The router of claim 11, wherein, if destination vector is updated, the updated destination vector is included in the spike data packet or the copy of the spike data packet sent to the output port.

13. The router of claim 10, further configured to derive a plurality of new destination vectors from the destination vector when more than one next destination for the spike data packet is determined, wherein the destinations indicated in the destination vector are divided among the plurality of new destination vectors, and wherein each one of the spike data packets sent to an output port includes one of the new destination vectors.

14. The router of claim 10, wherein the spike data contained in the spike data packets indicates which neurons in the source neuromorphic array core produced a spike within a certain time period.

15. The router of claim 10, wherein each of the spike data packets comprises timing data indicating a time period during which the spikes were produced.

16. The router of claim 10, wherein the destination vector is a destination bit vector comprising a plurality of bits, each bit indicating if a corresponding one of the neuromorphic array cores of the neuromorphic processor is a destination of the spike data packet.

17. The router of claim 10, further configured to transmit at least a portion of the spike data to one or more neurons in the receiving neuromorphic array core based on the source identity if the destination vector indicates that the receiving neuromorphic array core is a destination for the spike data packet.

18. The router of claim 10, wherein each of the spike data packets comprises data regarding a next destination of the spike data packet in addition to the destination bit vector.

19. An interconnect for multicasting spikes in a neuromorphic processor, wherein the interconnect comprises a plurality of routers according to claim 10 and a plurality of communication links connecting the routers.

20. A neuromorphic processor comprising a plurality of neuromorphic array cores, each of the neuromorphic array cores comprising a spiking neural network and having an associated router, the neuromorphic processor further comprising a plurality of communication links connecting the routers, and wherein the routers are routers according to claim 10.
